(19) United States
(12) Patent Application Publication
(10) Pub. No.: US 2020/0193525 A1
(43) Pub. Date: Jun. 18, 2020

(54) SYSTEM AND METHOD FOR AUTOMATIC VERIFICATION OF EXPENSE NOTE

(71) Applicant: MOBILEXPENSE NV, Brussels (BE)

(72) Inventor: Rodolphe VERMER, Brussels (BE)

(21) Appl. No.: 16/712,038

(22) Filed: Dec. 12, 2019

(30) Foreign Application Priority Data
Dec. 12, 2018 (BE) 2018-5884

(51) Int. Cl. G06Q 40/00; G06K 9/00; G06T 11/00

(52) U.S. Cl. CPC G06Q 40/12; G06K 2209/01; G06T 11/001; G06K 9/00469

(57) ABSTRACT

Methods and systems are disclosed for automatic processing of expense note information. The method automatically extracts the values corresponding to the key fields from the uploaded expense note using the OCR technology, and evaluates the OCR extracted values with respect to the transaction information associated with the individual users. After evaluation, fields are categorized into three or more classes depending on whether the information is verified, not verified, not available/optional, or OCR result is not available. Further, a grid display is generated corresponding to each of the expense notes providing an overview of what fields have been automatically verified or not verified, thus simplifying the task of controller to focus only on the fields that have not been verified.

### CROSS-REFERENCE TO RELATED APPLICATIONS

This application claims priority to the Belgian patent application BE2018/5884 filed Dec. 12, 2018, the disclosure of which is hereby incorporated by reference.

### TECHNICAL FIELD

The invention relates to automatic expense note verification system using OCR technology. More particularly, the invention relates to optimizing the task of controllers for expense note verification.

### BACKGROUND

Travel and travel-related expenses represent an important part of operational cost of any organization. Large numbers of entries are managed by the organization for reimbursement purpose. Many organizations use manual, paper-based processes to manage Travel expenses. This traditional management of paper based process expenses has many disadvantages.

A disadvantage is that it's a time consuming process for many people: employees, accounting, supervisors and more.

Another disadvantage is that it is a complex and inefficient corporate procedure. An additional disadvantage is that there is a high risk of fraud, errors and mistakes.

There is a need in the art to better analyze, monitor, and control these expenses, while maintaining accuracy and increasing worker productivity.

To automate the process of travel or other expense reimbursement, organizations are adopting various methods using Optical Character Recognition technology. In such methods scanned copies or images of the bills/invoices are received from the users and analyzed using OCR technology to extract user expense information which is then verified by controller (or any other designated employee) manually. This step though makes the task of validation easier but the controllers in the organization still need to validate the OCR extracted information with the information provided by the user. During validation process, the invoices where the information is not validated, the controller has to check each and every field of the expense note to identify which part has not been verified automatically. Validating such type of expense information is a time consuming process and requires a great deal of attention to accurately verify information related to each and every field.

Additionally, US 2006/0089907 discloses a process for Invoice verification. The automatic verification of invoice/bill is performed by comparing content received in the invoice to records that are maintained describing the transaction. However, it does not provide field wise categorization/display of invoices. It either accepts or rejects invoices for approval. Thus, controller has to validate all the invalidated invoices which are rejected by system by verifying each and every field, consuming a considerable amount of time.

In order to solve above problems, there is a need in the art to automate the validation process so that the time required for controller can be reduced thus optimizing operational cost for organization.

It is the object of the present invention to provide a solution to one or more of the aforementioned and other disadvantages, in that it provides a method for automating the verification process of expense notes.

It is also an object of the present invention to provide the grid level visual representation of the key fields to indicate the verified and non-verified data values.

It is also an object of the present invention to optimize the time spent by the controller for verification of the expense notes.

It is also an object of the present invention to identify the exact key fields that are verified and not verified and require controller re-verification.

Further, the object of the invention is to simplify the controller expense note verification process.

### SUMMARY OF THE INVENTION

According to the present invention the object is achieved by an expense note verification system

The present invention provides systems and methods for automatic verification system using OCR technology. It allows controllers to focus mainly on expense note where the information mentioned by the users was not verified, thus saving lot of time which was otherwise wasted in manual processing.

The present invention provides Methods and systems for automatic processing the expense note in a manner that reduces time for verifying the expense note details. The method automatically verifies the expense note field information by extracting the expense note information using OCR technology and comparing it with the transactional information provided by the user.

The present invention provides a method for categorization of extracted data into three or more classes based on the expense note evaluation. After evaluation, fields are categorized into three or more classes depending on whether the information is verified, not verified, not available/optional, or OCR result is not available.

The present invention provides a method and system to acquire transactional information associated with the expense note automatically.

An advantage is that the controller doesn't have to check each and every field associated with the expense field.

An additional advantage is that the time required for verifying the expense field is less.

Another additional advantage is that it will reduce the effective cost required in the optimization process.

Yet another advantage is that this process is effective and error free.

### DESCRIPTION OF FIGURES

In the drawings:

FIG. 1 is a block diagram of architecture of an automated expense note verification system

FIG. 2 illustrates the process flow for automatic expense note verification.

FIG. 3 depicts an exemplary grid generated as an output of the graphical module FIG. 4 illustrates the controller's view to process the expense note.

FIG. 5 illustrates the steps involved in automatic processing of expense note

### DETAILED DESCRIPTION OF THE INVENTION

While this solution may be subject to various modifications and take alternative forms, it has been illustrated as an example in the accompanying drawings and will be described in detail below. However, it should be understood that this solution is not intended to be limited to the specific forms disclosed.

Some aspects comparable in terms of scope, the disclosed embodiments are described below. It should be understood that these aspects are presented merely to provide the reader with a brief summary of certain forms that could take the solution and that these aspects are not intended to limit its scope. Indeed, this solution can encompass a variety of aspects that may not be defined below.

As used herein, the terms user, individual user, and individual may be used interchangeably with each other. The present invention is also applicable to “one or more individual users” as described in the claim, includes plurality of users, individual users, individuals.

The term “computer” may include a plurality of possible devices, such as tablet, personal digital assistant (PDA), and any sort of mobile computing device known in the art.

The term “controller” defined as a person in the customer organization responsible for verifying that the user has provided an evidence of the spend.

The term “expense” may be defined as an item of expenditure incurred by user whilst performing their work for customer organization.

The term “expense note” maybe invoice, bill, expense note, statement of charges, and any sort of statement known in the art.

The term “expense category” describes the type of expense incurred by user i.e. travel, hotel, lunch, parking, etc.

The digital copy of the receipts may be obtained from a camera, or by scanning the expense notes using a scanner. Further, the digital copy may be of any image format such as, JPEG, GIF, PNG, etc., or any document format such as, PDF, DOC, XPS, etc.

OCR technology used herein has the same meaning as commonly understood by one of ordinary skill in the art to which this invention belongs and by reference to published texts, which provide one skilled in the art with a general guide to many of the terms used in the present application.

The definitions are provided for clarity only and are not intended to limit the claimed invention.

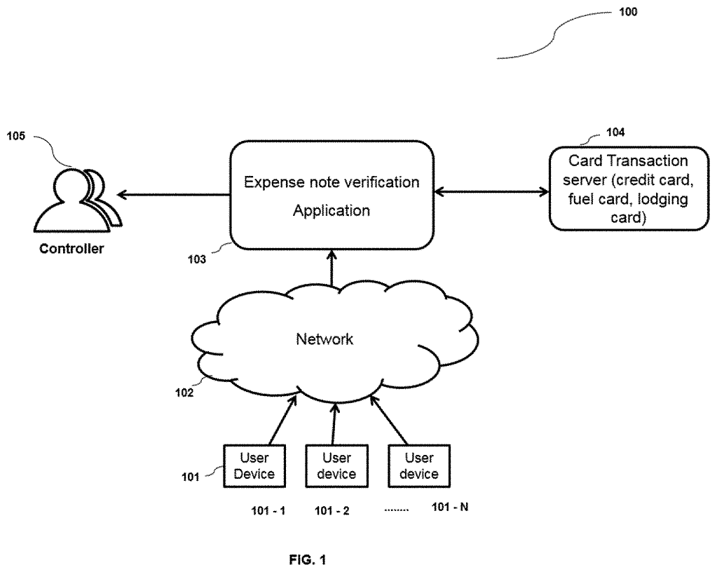

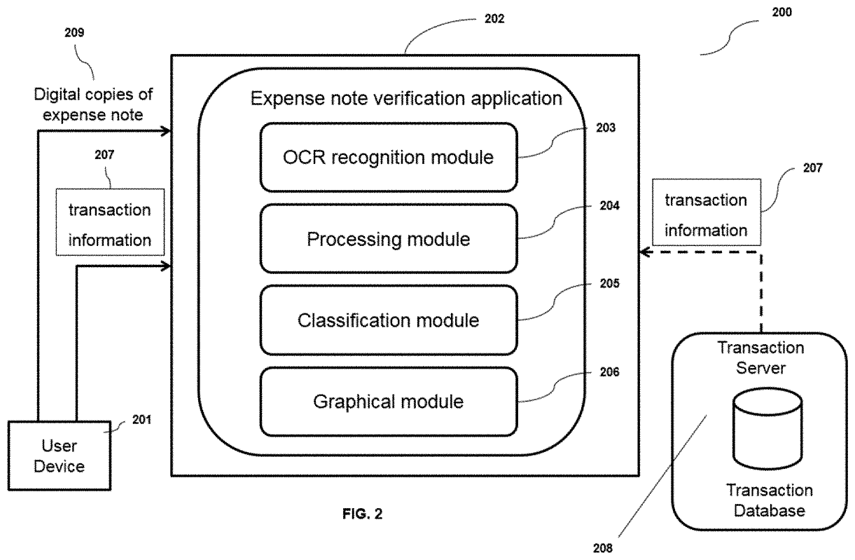

FIG. 1 shows an exemplary network environment 100, for implementation of an automated expense note verification system. As shown in the FIG. 1, the exemplary network environment 100 includes an expense note verification application 103, one or more user devices 101-1 . . . 101-N, herein collectively referred as the user devices 101 and individually referred as the user device 101. The expense management application 103 is accessible to one or more controllers 106 of organizations. The network environment 100 also includes access to transaction servers 105 providing details related to various cards (credit card, fuel card, lodging card, etc.) for expense settlement. The network environment 100 may further include access to servers of National Banks 104 or for example Xe.com for gathering information related to exchange rates. The expense note verification application 103, the transaction server 105, exchange rate data server 104 and the user devices 101 may communicate over a network 102.

The expense note verification application 103 may be configured to receive digital copies of one or more expense notes, corresponding to the expenses incurred by the user, via the user devices 101. The digital copy of the expense notes may be obtained from a camera, or by scanning the expense notes using a scanner. Further, the digital copy may be of any image format such as, JPEG, GIF, PNG, etc., or any document format such as, PDF, DOC, XPS, etc. The expense notes may be provided for the purpose of reimbursements for the costs incurred by the user for business purposes. The expense notes may be provided to the user by multiple vendors or service providers.

A user device 101 may be any device capable of transmitting data, such as the digital copies of the expense notes, to the expense management application 103. Examples of the user devices 101 may include, without limitation, personal computers, cellular communication devices, Hand-Held display devices, smart phones, personal digital assistants (PDAs), tablets, notebook computers, and the like. The user device 101 may also be capable of generating the digital copies of the expense notes, for example, taking images or scanning the expense notes. The user devices 101 may include suitable hardware and/or software for connecting to the expense management application 103 through the network 102.

Expense management application (103) may acquire information related to transaction corresponding to expense incurred by user from the card transaction (credit card, debit card, lodging card, fuel card etc.) server (105) for automated processing.

After processing of expense note, the results are displayed to the controller 105.

FIG. 2 illustrates the process flow for automatic expense note verification. The diagram describes the interaction between various components of the automated expense note verification system 200. The computing device hosts a software application for expense note verification at the controller's end. The computing device 202 shown in the diagram can be anything from a laptop, computer, workstation, pc or mobile, tablet, personal digital assistant (PDA) and any sort of mobile computing device known in the art.

As depicted in the diagram, the user submits digital copies 209 of expense notes in the form of one or more images or scanned copies. The user provides expense details on the application running on user devices by manually entering the transaction information 207 such as date of transaction, category of expense, country and gross amount. The user further attaches a receipt (expense note) by scanning it or alternatively taking an image of the receipt via a camera attached to the user device 201. The transactional details along with the receipt image are transmitted to the expense note verification application running on the controller's computing device 202 for validation purpose.

Alternatively, the transactional information can be fetched automatically by the expense note verification application from transaction servers 208 hosting details of transactions performed using various corporate cards issued to the user.

The digital copies of the expense notes are received by OCR recognition module 203. The OCR recognition module 203 extracts data corresponding to key fields in the receipts such as merchant name, city name, VAT, Gross amount, date, etc.

The processing module 204 compares the transactional information 207 to the OCR extracted key field values of the expense note to validate that the transactional details provided by the users are same.

The classification module 205 categorizes the key fields into three or more categories of verified, not verified, optional or not available. Further it assigns colors to these fields depending on the validation status of key field.

The graphical module 206 displays the output of the verification status of the key fields in the form of visual representation. In one of the embodiment it can be represent in form of grid wherein different square boxes represent different key fields.

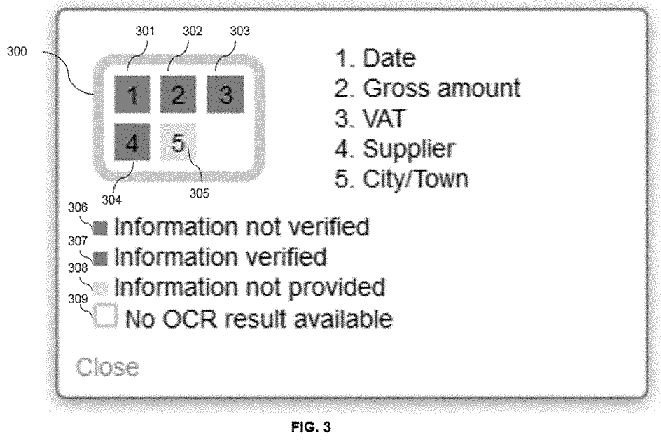

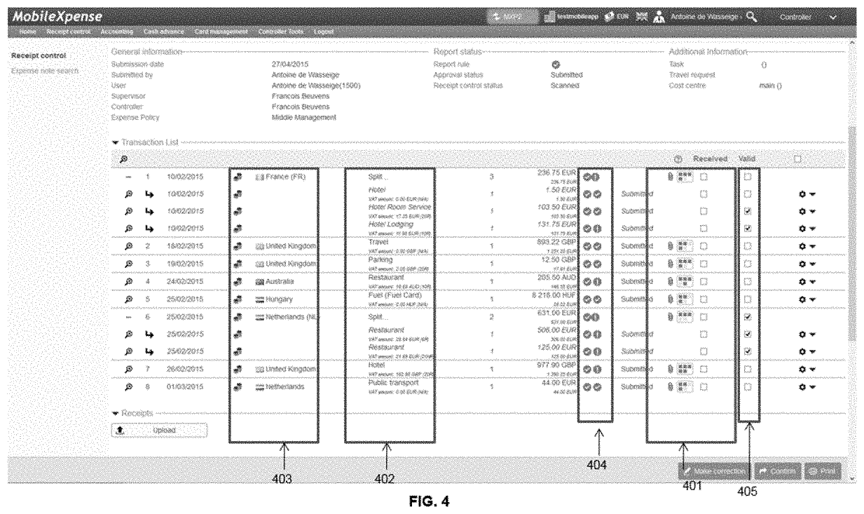

FIG. 3 depicts an exemplary grid generated as an output of the graphical module.

As shown in the figure, the grid 300 comprises of validation status output of five data field values 301, 302, 303, 304, 305. The data fields may be selected from a range of financial and non-financial fields available on a receipt/invoice/expense note. As depicted in the diagram, 301 represents Date as mentioned on the receipt, 302 represents gross amount, 303 represents VAT, 304 represents supplier/merchant and 305 represents the city where the transaction has taken place. Further it is shown in the figure that each of the squares in the grid corresponding to different fields are filled with colors which are decided based on the validation status obtained after comparing the transactional values with the OCR extracted values. The figure provides the definition of the colors—the color in 306 represents that the information is not-verified, the color in 307 represents that the information is verified, the color in 308 represents that the information is not provided and the color in 309 represents that OCR result is not available.

As an example case, the color represented by 306 is red and it indicates that the information of that field is not verified. The color represented by 307 is green and it indicates that the information of that field is verified. The color represented by 308 is grey and it indicates that the information of that field is not provided. The square 309 is blank and it indicates that the OCR result for that field is not available.

FIG. 4 illustrates the controller's view to process the expense note. As shown in the figure multiple grids 401 corresponding to one or more user represent the validated key fields. The key fields are validated by considering one or more organizational rules/policy. The rules/policy may be mileage allowance, permitted allowance per user, lodging allowance, food allowance, and like. The column 404 indicates whether the expenses incurred by the user are in compliance with the organizational rules with the help of visual representation (like by displaying a tick, color code or an exclamation mark). The system also compares the transactional information provided by users to their corresponding expense note's extracted data. Different status of the fields of expense note is arranged in different colors. As an example case, Red color indicates information is not verified, green color indicates information is verified, grey color represents that information is not available and blank represents that OCR result for the field is not available. It eases controller's task as controller has to focus only on the fields which are not verified (example red color square). The view also shows the expense category 402, the split of spending of amount for one or more user at various places. The name of the country is shown in the column next to the expense category 403. Column 405 titled “Valid VAT receipt” indicates whether the receipt is a VAT receipt or not. The controller checks the boxes next to the receipts which are valid VAT receipts and unchecks those that are not valid VAT. The VAT cannot be recorded and reclaimed for the invalid VAT receipts and the system forces the VAT amount to 0 for such receipts while processing.

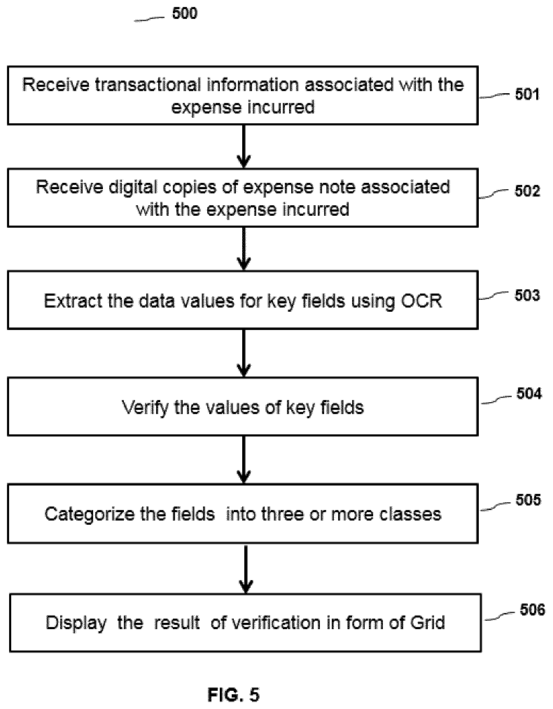

Referring now to FIG. 5, the block diagram 500 illustrates the steps involved in automatic processing of an expense note. In the first step 501, the expense note management system receives the transaction information associated with the expenses incurred by the user which may be manually entered by the user at an application interface on their user device or alternatively automatically received from the transaction servers of various cards that were used to make payments for the expenses. At step 502, digital copy of expense note associated with the expense incurred by one or more individual users is received by the expense management system. At step 503, data corresponding to most important fields in the receipts such as merchant name, city name, VAT, Gross amount, date, etc., are extracted using optical character recognition (OCR) technology. At step 504, the OCR extracted values are compared with the transaction information received at step 501 to validate that the transactional details provided by the users are correct and are the same as present in the receipts provided by them. At step 505, the data fields are categorized into three or more categories of verified, not verified, optional or not available. Further colors are assigned to these fields depending on the validation status. Finally, at step 506, the result of the validation and categorization are displayed in the form of a grid representing the output of expense note verification for review by the controllers.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

1. An automatic expense note verification method for assessing one or more expense note information associated with one or more individual users, the method comprising the steps of:
a. receiving transactional information associated with an expense incurred by one or more individual users;
b. receiving a digital copy of an expense note associated with the expense incurred by one or more individual users;
c. extracting a set of data values corresponding to key fields from the expense note using optical character recognition (OCR) technology;
d. validating the OCR extracted data values by comparing the OCR extracted data values with the transactional information associated with the user;
e. categorizing the key fields into three or more classes based on the result of the comparison; and
f. displaying an output of validation corresponding to each key field in the form of a grid.

2. The method of claim 1, wherein the expense note information is received by using one or more communication channels chosen from internet, e-mail, a network and a portable storage device.

3. The method according to claim 1, wherein the key fields extracted using OCR are selected from financial and non-financial data for assessing the one or more expense note information.

4. The method according to claim 3, wherein the key fields of the financial data are selected from bill amount and VAT and the key fields of the non-financial data are selected from date of transaction, merchant name and city.

5. The method according to claim 1, wherein the three or more classes are represented by same or different colours based on the following validation status:
a. information pertaining to the field is verified,
b. information pertaining to the field is not verified,
c. information corresponding to the field is optional and not provided for the particular transaction, and
d. OCR result for the field is not available

6. The method of claim 1, wherein the transactional information associated with the expense incurred by one or more individual users is either submitted manually by the user or automatically provided by the transaction server.

7. The method according to claim 1, wherein the digital copy of the expense note associated with the expense incurred by one or more individual users is selected from one or more images or scanned copies.

8. An automatic expense note verification system (200) for assessing one or more expense note information associated with one or more individual users, the system comprising:
a. a computing device (202) connected to a network configured to receive transactional information (207) associated with an expense incurred by one or more individual users and to receive a digital copy of an expense note (209) associated with the expense incurred by one or more individual users;
b. a optical character recognition (203) module configured to extract a set of data values corresponding to key fields of an expense note record using optical character recognition (OCR) technology;
c. a processing module (204) configured to validate the OCR extracted data values by comparing the OCR extracted data values with the transactional information associated with the user;
d. a classification module (205) configured to categorize the key fields into three or more classes based on the result of the comparison; and
e. a graphical module (206) for displaying an output of validation corresponding to each key field in the form of a grid

9. The system of claim 8, wherein the expense note information is received by using one or more communication channels chosen from internet, e-mail, a network and a portable storage device.

10. The system of claim 8, wherein the key fields extracted using OCR are selected from financial and non-financial data for assessing the one or more expense note information.

11. The system of claim 10, wherein the key fields of the financial data are selected from bill amount and VAT and the key fields of the non-financial data fields are selected from date of transaction, merchant name, and city.

12. The system according to claim 8, wherein the three or more classes are represented by same or different colours based on the following validation status:
a. information pertaining to the field is verified,
b. information pertaining to the field is not verified,
c. information corresponding to the field is optional and not provided for the particular transaction, and
d. OCR result for the field is not available

13. The system of claim 8, wherein the transactional information associated with the expense incurred by one or more individual users is either submitted manually by the user or automatically provided by the transaction server

14. The system of claim 8, wherein the digital copy of the expense note associated with the expense incurred by one or more individual users can be selected from one or more images or scanned copies.
